(19) United States
(12) Patent Application Publication
(10) Pub. No.: US 2023/0252359 A1
(43) Pub. Date: Aug. 10, 2023

(54) NON-LINEAR MULTITASK SUPPORT VECTOR MACHINES

(71) Applicants: Aleksei Ponomarenko-Timofeev, Tampere (FI); Olga Galinina, Tampere (FI); Ravikumar Balakrishnan, Beaverton, OR (US); Arjun Anand, Milpitas, CA (US); Nageen Himayat, Fremont, CA (US); Sergey Andreev, Tampere (FI)

(72) Inventors: Aleksei Ponomarenko-Timofeev, Tampere (FI); Olga Galinina, Tampere (FI); Ravikumar Balakrishnan, Beaverton, OR (US); Arjun Anand, Milpitas, CA (US); Nageen Himayat, Fremont, CA (US); Sergey Andreev, Tampere (FI)

(21) Appl. No.: 18/137,811

(22) Filed: Apr. 21, 2023

Related U.S. Application Data
(60) Provisional application No. 63/333,857, filed on Apr. 22, 2022.

(51) Int. Cl. G06N 20/10

(52) U.S. Cl. CPC G06N 20/10

(57) ABSTRACT

Techniques for non-linear distributed multitask support vector machines are disclosed. In the illustrative embodiment, a coordinator node sends initial parameters (or a random number generator along with model choice) for a global model to participant nodes. Each participant node performs a round of training based on the common global model parameters, the model models, and local data. Each participant node determines updated parameters for the global model and updated parameters for a local model. Each participant node sends an update of the parameters to the global model to the coordinator node, while keeping the parameters of the local model private. The coordinator node aggregates the updates from the participant nodes, updates the global model parameters, and sends them back to the participant nodes. The process can repeat until a desired error level is reached.

### CROSS-REFERENCE TO RELATED APPLICATIONS

This application claims the benefit of U.S. provisional patent application No. 63/333,857, filed Apr. 22, 2022, and entitled “NON-LINEAR MULTITASK SUPPORT VECTOR MACHINES.” The disclosure of the prior application is considered part of and is hereby incorporated by reference in its entirety in the disclosure of this application.

### BACKGROUND

Machine learning techniques offer powerful solutions to a range of problems, such as classification, regression, and anomaly detection. Approaches for solving such problems in a distributed setting include neural networks and statistical methods. An anomaly detection problem can be solved with neural network (NN) methods (e.g., autoencoder), statistical methods (one-class support vector machine or SVM), or by analyzing similarity metrics such as Mahalanobis distance. Classification and regression problems can be solved with statistical methods (e.g., SVM), convolutional neural networks (CNN), or any other suitable neural network. Statistical heterogeneity challenge of on-device data can be addressed separately through the multitask formulation. However, multitask SVM solutions are not generally applicable in a distributed environment.

### BRIEF DESCRIPTION OF THE DRAWINGS

FIG. 1 is a simplified block diagram of at least one embodiment of a system for training a non-linear multitask support vector machine (SVM).

FIG. 2 is a simplified block diagram of at least one embodiment of a compute device that may act as a coordinator node of the system of FIG. 1.

FIG. 3 is a simplified block diagram of at least one embodiment of an environment that may be established by a coordinator node of FIG. 1.

FIG. 4 is a simplified block diagram of at least one embodiment of an environment that may be established by a participant node of FIG. 1.

FIGS. 5 and 6 are a simplified flow diagram of at least one embodiment of a method for training a non-linear multitask SVM that may be executed by a coordinator node of FIG. 1.

FIG. 7 is a simplified flow diagram of at least one embodiment of a method for training a non-linear multitask SVM that may be executed by a participant node of FIG. 1.

FIG. 8 is a plot of one embodiment of model error as a function of time for several different models.

FIG. 9 are plots of one embodiment of a multitask SVM with two features.

FIG. 10 is a simplified diagram showing a calculation of an update to a parameter.

FIG. 11 is a simplified diagram showing a calculation of an update to a parameter with continuous subsampling.

FIG. 12 is a simplified diagram showing a calculation of an update to a parameter with discrete subsampling.

FIG. 13 are plot of one embodiment of model error as a function of time for different subsampling approaches.

### DETAILED DESCRIPTION

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

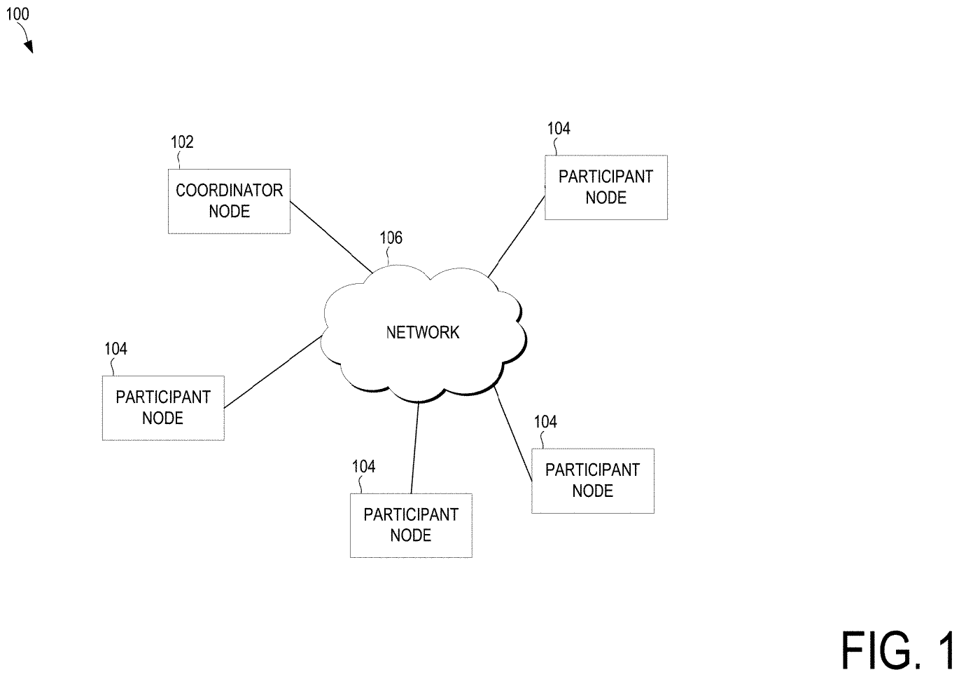

Referring now to FIG. 1, an illustrative system 100 includes a coordinator node 102 and several participant nodes 104 connected by a network 106. In the illustrative embodiment, the coordinator node 102 and participant nodes 104 train a non-linear multitask support vector machine (SVM). The coordinator node 102 and the participant nodes 104 share parameters for a global model of an SVM, and each participant node 104 trains a set of local parameters that are used to both update the global model of the SVM as well as to train local parameters that are used to better match the local data. Random Fourier feature mapping (RFFM) may be used to approximate kernels in the distributed scenario. The alternating direction method of multipliers (ADMM) is used to converge to local and global models faster than conventional stochastic gradient descent.

The approach described herein allows for the multitask SVM to be trained on data that is not independent and identically distributed random variables (IID) across the participant nodes 104. The training data is linearly inseparable. The privacy of local data is enhanced by using a subsampling technique when performing training at each participating node. The approach can be used for classification, regression, and/or anomaly detection.

In an illustrative embodiment, transition to the stable operation occurred within 10 iterations in the case of the anomaly detection training procedure on selected datasets. The distributed algorithms for classification/regression converged to the stable optimum within 1-5 iterations. A fast convergence can reduce processing time and network traffic during the training phase.

For datasets with a low number of points per task, in an illustrative embodiment, the achieved performance is higher compared to that of the corresponding methods that rely only on local training (termed local methods). For example, in one embodiment, in the 10-task set derived from a commonly adopted ECG5000 (approximately 30 training points available for each task), the local SVM method, in which participant nodes 104 do not communicate with any other nodes 102, 104, reached the precision of 0.83, while the multitask SVM (MT-SVM) described herein reached the precision of 0.93.

In tests against the MOCHA multitask classification algorithm, the multitask SVM described herein yields a 10% reduction in run time. In one embodiment, tests performed on a Lenovo® P330 workstation with Intel® Core i7-8700 CPU and achieved the following timings for 300 iterations:

| Method | Mean delay (s) | Delay STD (s) |
|---|---|---|
| MOCHA | 5.28 | 0.07 |
| MT-SVM | 4.47 | 0.03 |

The coordinator node 102 and the participant node 104 may be any suitable compute devices. In the illustrative embodiment, the coordinator node 102 and participant nodes 104 may be any suitable device that can communicate over a network 106, such as a server computer, a rack computer, a desktop computer, a laptop, a mobile device, a cell phone, a router, a switch, etc. For example, the coordinator node 102 and participant nodes 104 may be sleds in a rack of a datacenter, and the network 106 may be embodied as cables, routers, switches, etc., that connect racks in a datacenter. In one simplified embodiment, the system 100 includes one coordinator node 102 and four participant nodes 104, as shown. Of course, in other embodiments, the system 100 may include any suitable number of coordinator node 102 and participant nodes 104, such as one to hundreds of coordinator nodes 102 and two to millions of participant nodes 104. The system 100 may include any suitable data center, such as an edge network, a cloud data center, an edge data center, a micro data center, a multi-access edge computing (MEC) environment, etc. Additionally or alternatively, in some embodiments, one or both of the coordinator node 102 and participant nodes 104 may be outside of a data center, such as coordinator node 102 and participant nodes 104 that form part of or connect to an edge network, a cellular network, a home network, a business network, a satellite network, etc.

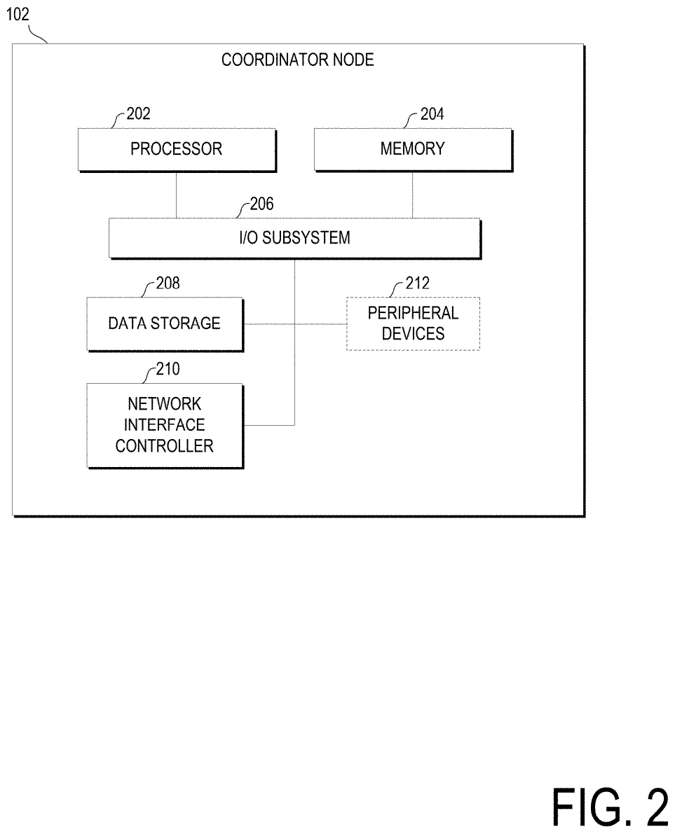

Referring now to FIG. 2, a simplified block diagram of a coordinator node 102 is shown. The coordinator node 102 may be embodied as any type of compute device. For example, the coordinator node 102 may be embodied as or otherwise be included in, without limitation, a server computer, an embedded computing system, a System-on-a-Chip (SoC), a multiprocessor system, a processor-based system, a consumer electronic device, a smartphone, a cellular phone, a desktop computer, a tablet computer, a notebook computer, a laptop computer, a network device, a router, a switch, a networked computer, a wearable computer, a handset, a messaging device, a camera device, a distributed computing system, and/or any other computing device. The illustrative coordinator node 102 includes a processor 202, a memory 204, an input/output (I/O) subsystem 206, data storage 208, a network interface controller (NIC) 210, and one or more optional peripheral devices 212. In some embodiments, one or more of the illustrative components of the coordinator node 102 may be incorporated in, or otherwise form a portion of, another component. For example, the memory 204, or portions thereof, may be incorporated in the processor 202 in some embodiments.

In some embodiments, the coordinator node 102 may be located in a data center with other compute devices 102, such as an enterprise data center (e.g., a data center owned and operated by a company and typically located on company premises), managed services data center (e.g., a data center managed by a third party on behalf of a company), a colocated data center (e.g., a data center in which data center infrastructure is provided by the data center host and a company provides and manages their own data center components (servers, etc.)), cloud data center (e.g., a data center operated by a cloud services provider that host companies applications and data), and an edge data center (e.g., a data center, typically having a smaller footprint than other data center types, located close to the geographic area that it serves), a micro data center, etc.

The processor 202 may be embodied as any type of processor capable of performing the functions described herein. For example, the processor 202 may be embodied as a single or multi-core processor(s), a single or multi-socket processor, a digital signal processor, a graphics processor, a neural network compute engine, an image processor, a microcontroller, an infrastructure processing unit (IPU), a data processing unit (DPU), an xPU, or other processor or processing/controlling circuit. The processor 202 may include any suitable number of cores, such as any number from 1-1,024.

The memory 204 may be embodied as any type of volatile or non-volatile memory or data storage capable of performing the functions described herein. In operation, the memory 204 may store various data and software used during operation of the coordinator node 102, such as operating systems, applications, programs, libraries, and drivers. The memory 204 is communicatively coupled to the processor 202 via the I/O subsystem 206, which may be embodied as circuitry and/or components to facilitate input/output operations with the processor 202, the memory 204, and other components of the coordinator node 102. For example, the I/O subsystem 206 may be embodied as, or otherwise include, memory controller hubs, input/output control hubs, firmware devices, communication links (e.g., point-to-point links, bus links, wires, cables, light guides, printed circuit board traces, etc.) and/or other components and subsystems to facilitate the input/output operations. The I/O subsystem 206 may connect various internal and external components of the coordinator node 102 to each other with use of any suitable connector, interconnect, bus, protocol, etc., such as an SoC fabric, PCIe®, USB2, USB3, USB4, NVMe®, Thunderbolt®, and/or the like. In some embodiments, the I/O subsystem 206 may form a portion of a system-on-a-chip (SoC) and be incorporated, along with the processor 202, the memory 204, the NIC 210, and other components of the coordinator node 102 on a single integrated circuit chip.

The data storage 208 may be embodied as any type of device or devices configured for the short-term or long-term storage of data. For example, the data storage 208 may include any one or more memory devices and circuits, memory cards, hard disk drives, solid-state drives, or other data storage devices.

The NIC 210 may be embodied as any type of interface capable of interfacing the coordinator node 102 with other compute devices, such as over one or more wired or wireless connections. In some embodiments, the NIC 210 may be capable of interfacing with any appropriate cable type, such as an electrical cable or an optical cable. The NIC 210 may be configured to use any one or more communication technology and associated protocols (e.g., Ethernet, Bluetooth®, Wi-Fi®, WiMAX, near field communication (NFC), 4G, 5G, etc.). The NIC 210 may be located on silicon separate from the processor 202, or the NIC 210 may be included in a multi-chip package with the processor 202, or even on the same die as the processor 202. The NIC 210 may be embodied as one or more add-in-boards, daughtercards, network interface cards, controller chips, chipsets, specialized components such as a field-programmable gate array (FPGA) or application-specific integrated circuit (ASIC), or other devices that may be used by the coordinator node 102 to connect with another compute device. In some embodiments, MC 210 may be embodied as part of a system-on-a-chip (SoC) that includes one or more processors, or included on a multichip package that also contains one or more processors.

In some embodiments, the coordinator node 102 may include other or additional components, such as those commonly found in a compute device. For example, the coordinator node 102 may also have peripheral devices 212, such as a keyboard, a mouse, a speaker, a microphone, a display, a camera, a battery, an external storage device, etc.

In the illustrative embodiment, the participant nodes 104 may have components such as hardware, software, and firmware that are similar to or the same as the coordinator node 102, a description of which will not be repeated in the interest of clarity. Of course, the various components of a coordinator node 102 and a participant node 104 may be different in any particular embodiment. For example, the coordinator node 102 may have a more powerful processor 202 and more memory 204 than that of a participant node 104, or vice-versa.

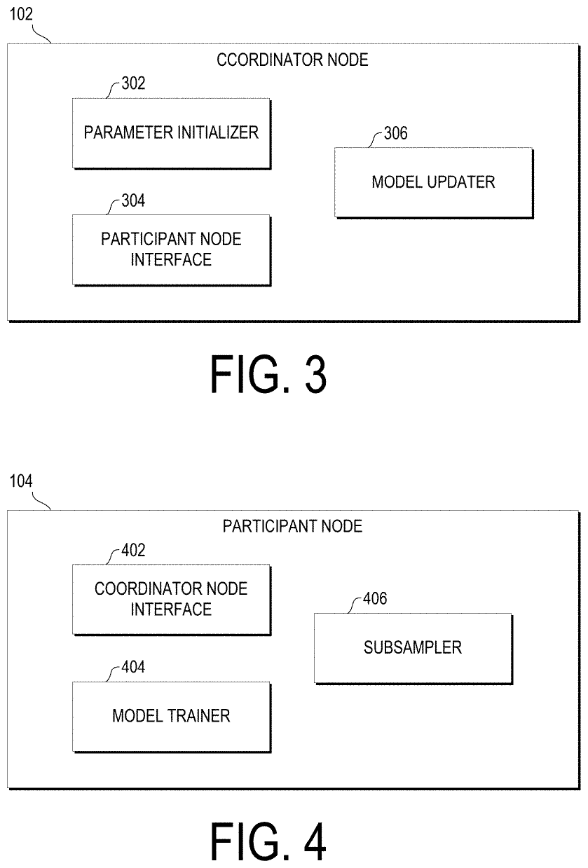

Referring now to FIG. 3, in an illustrative embodiment, the coordinator node 102 establishes an environment 300 during operation. The illustrative environment 300 includes a parameter initializer 302, a participant node interface 304, and a model updater 306. The various modules of the environment 300 may be embodied as hardware, software, firmware, or a combination thereof. For example, the various modules, logic, and other components of the environment 300 may form a portion of, or otherwise be established by, the processor 202, the memory 204, the data storage 208, or other hardware components of the coordinator node 102. As such, in some embodiments, one or more of the modules of the environment 300 may be embodied as circuitry or collection of electrical devices (e.g., parameter initializer circuitry 302, participant node interface circuitry 304, model updater circuitry 306, etc.). It should be appreciated that, in such embodiments, one or more of the circuits (e.g., the parameter initializer circuitry 302, the participant node interface circuitry 304, the model updater circuitry 306, etc.) may form a portion of one or more of the processor 202, the memory 204, the I/O subsystem 206, the data storage 208, and/or other components of the coordinator node 102. For example, in some embodiments, some or all of the modules may be embodied as the processor 202, as well as the memory 204 and/or data storage 208 storing instructions to be executed by the processor 202. Additionally, in some embodiments, one or more of the illustrative modules may form a portion of another module and/or one or more of the illustrative modules may be independent of one another. Further, in some embodiments, one or more of the modules of the environment 300 may be embodied as virtualized hardware components or emulated architecture, which may be established and maintained by the processor 202 or other components of the coordinator node 102. It should be appreciated that some of the functionality of one or more of the modules of the environment 300 may require a hardware implementation, in which case embodiments of modules that implement such functionality will be embodied at least partially as hardware.

The parameter initializer 302, which may be embodied as hardware, firmware, software, virtualized hardware, emulated architecture, and/or a combination thereof as discussed above, is configured to determine initial global parameters for a global SVM model. The initial global parameters for the global SVM include a feature mapping such as a random Fourier feature mapping (RFFM), a vector normal to a hyperplane, and one or more sets of regularization parameters. The vector normal to a hyperplane may be initialized to any suitable value, such as all zeros or all ones. The SVM model, including the global and local aspects, is described in more detail below in regard to FIG. 4.

Each set of regularization parameters includes a parameter C1, which defines the sensitivity or tolerance to errors caused by outliers, and a parameter C2, which defines the relative weighting between the global model and the local model. The parameter initializer 302 determines different combinations of regularization parameters. The parameter initializer 302 generates a relatively large number of sets of regularization parameters for initial training, and the sets of regularization parameters that result in poorer models will be discarded by the model updater 306. The parameter initializer 302 may initially generate any suitable number of sets of regularization parameters, such as 1-1,000.

In some embodiments, the parameter initializer 302 may determine mapping parameters based on a seed for a random number generator (RNG). In such an embodiment, the coordinator node 102 needs only to send the seed for the RNG to the participant nodes 104 in order for the participant nodes 104 and coordinator node 102 to share the initial mapping parameters.

The participant node interface 304, which may be embodied as hardware, firmware, software, virtualized hardware, emulated architecture, and/or a combination thereof as discussed above, is configured to send the global parameters to each of the participant nodes 104. The participant node interface 304 may include a unique identifier (UID) generated to identify the model being trained in the system 100. In some embodiments, the values of the vector normal to a hyperplane may not be sent as part of the initial message to the participant nodes 104 with the rest of the parameters as its initial value may already be known by the participant nodes 104. In some embodiments, the participant node interface 304 may send a seed for a RNG in addition to or instead of other mapping parameters.

After sending global model parameters to the participant nodes 104, the participant node interface 304 waits for updates from the participant nodes 104. In some embodiments, the participant node interface 304 may wait a pre-defined amount of time. Additionally or alternatively, the participant node interface 304 may wait until a certain fraction of participant nodes 104 have sent back data, such as 10-100% of participant nodes 104.

Each update the participant node interface 304 receives includes parameters indicating a new vector normal to a hyperplane for the global model for each set of regularization parameters the coordinator node 102 sent the participant node. The update may also include a parameter indicating how well the model for each set of regularization parameters fit the local data. The parameters indicating a new vector normal to a hyperplane may be, e.g., the values of the vector normal to a hyperplane or the difference between the updated values of the vector normal to a hyperplane and the previous values of the vector normal to a hyperplane. In some embodiments, the update may include the task UID and a timestamp. The timestamp may be used to indicate whether the update corresponds to the current training round. It should be appreciated that, in the illustrative embodiment, each participant node 104 also calculates updates to a local model that is not shared with the coordinator node 102.

After the model updater 306 updates the model as described below, the participant node interface 304 sends updated global parameters to the participant nodes 104. The participant node interface 304 sends parameters indicating the updates to the global vector normal to a hyperplane. The parameters indicating a new hyperplane vector may be, e.g., the values of the vector normal to a hyperplane or the difference between the updated values of the vector normal to a hyperplane and the previous values of the vector normal to a hyperplane. The participant node interface 304 may also send the updated combination of regularization parameters.

The model updater 306, which may be embodied as hardware, firmware, software, virtualized hardware, emulated architecture, and/or a combination thereof as discussed above, is configured to determine updates to the global model. For example, the model updater 306 may determine an average of the vector normal to a hyperplane determined by each coordinator node 102. The average may be weighted by, e.g., the amount of data each coordinator node 102 has. This can also be a sum of the updates shared by each of the participating nodes 104.

In some embodiments, the model updater 306 may also determine whether a combination of regularization parameters should be removed. In the illustrative embodiment, the model updater 306 may remove the lowest-performing set of regularization parameters until a minimum viable number of combinations of parameters are left, such as 1-10. In other embodiments, the model updater 306 may decide to remove one or more sets of regularization parameters based on any suitable metric, such as removing all sets of regularization parameters below a certain performance level, which may change depending on what round of training the system 100 is on.

Referring now to FIG. 4, in an illustrative embodiment, the participant node 104 establishes an environment 300 during operation. The illustrative environment 400 includes a coordinator node interface 402, a model trainer 404, and a subsampler 406. The various modules of the environment 400 may be embodied as hardware, software, firmware, or a combination thereof. For example, the various modules, logic, and other components of the environment 400 may form a portion of, or otherwise be established by, the processor 202, the memory 204, the data storage 208, or other hardware components of the participant node 104. As such, in some embodiments, one or more of the modules of the environment 400 may be embodied as circuitry or collection of electrical devices (e.g., coordinator node interface circuitry 402, model trainer circuitry 404, and subsampler circuitry 406, etc.). It should be appreciated that, in such embodiments, one or more of the circuits (e.g., the coordinator node interface circuitry 402, the model trainer circuitry 404, and the subsampler circuitry 406, etc.) may form a portion of one or more of the processor 202, the memory 204, the I/O subsystem 206, the data storage 208, and/or other components of the participant node 104. For example, in some embodiments, some or all of the modules may be embodied as the processor 202, as well as the memory 204 and/or data storage 208 storing instructions to be executed by the processor 202. Additionally, in some embodiments, one or more of the illustrative modules may form a portion of another module and/or one or more of the illustrative modules may be independent of one another. Further, in some embodiments, one or more of the modules of the environment 400 may be embodied as virtualized hardware components or emulated architecture, which may be established and maintained by the processor 202 or other components of the participant node 104. It should be appreciated that some of the functionality of one or more of the modules of the environment 400 may require a hardware implementation, in which case embodiments of modules that implement such functionality will be embodied at least partially as hardware.

The coordinator node interface 402, which may be embodied as hardware, firmware, software, virtualized hardware, emulated architecture, and/or a combination thereof as discussed above, is configured to interface with a coordinator node 102. The coordinator node interface 402 may receive global parameters for a global SVM model. The global parameters for the global SVM include a feature mapping such as a random Fourier feature mapping (RFFM), a vector normal to a hyperplane, and one or more sets of regularization parameters. In some embodiments, the value of the initial vector normal to a hyperplane may already be known (e.g., may all be zeros or all ones), and the initial vector normal to a hyperplane may be omitted. The coordinator node interface 402 may receive several combinations of regularization parameters. The coordinator node interface 402 may also receive a seed for a RNG that can be used to generate the initial mapping parameters.

The model trainer 404, which may be embodied as hardware, firmware, software, virtualized hardware, emulated architecture, and/or a combination thereof as discussed above, is configured to train the SVM based on the local data. The system 100 may include T participant nodes 104, each holding a set of nₖ, k∈1 . . . T, feature vectors xᵢₖ of length d, xᵢₖ∈R^{d}, k ∈1, . . . , T, i∈1, . . . , nₖ. In the classification and regression cases, the model trainer 404 also keeps the corresponding labels yᵢₖ, k∈1, . . . , T, i∈1, . . . , nₖ. For the classification problem, the labels are the class of the point, and for the regression, the label is the value of the recovered function. For anomaly detection, the labels are not present in the system, so the model trainer 404 only has the unlabeled data points.

In the illustrative embodiment, the model trainer 404 applies a feature mapping, such as a random Fourier feature mapping, to transform the data before using the data to train the model. The model below is described in regard to the transformed data.

In the illustrative embodiment, the conventional SVM decision function is adapted to the distributed multitask model formulation as aₖ (x)=sig(w^{T}x+vₖ^{T}x) for classification/anomaly detection, where aₖ (x) indicates whether point x is determined to be in a class. For regression, the decision function is aₖ (x)=w^{T}x+vₖ^{T}x for regression, where aₖ (x) represents the predicted value for point x. For anomaly detection, an offset term ρₖ is introduced that corresponds to the offset in the decision function aₖ (x)=sig(w^{T}x+vₖ^{T}x+ρₖ). In the illustrative embodiment, in anomaly detection problems, the anomalies are initially assumed to be located at the origin of the feature space. Thus, an appropriate transform to the data is applied.

The model trainer 404 trains the model for each set of regularization parameters received from the coordinator node 102. The sensitivity to errors caused by outliers is regulated with constant C₁. The weight of the local model vₖ relative to the global model w is controlled by regularization constant C₂. If the data points of different participant nodes 104 have similar distributions in the feature space, the similarity can be captured in the global model. If the data is sufficiently different for different participant nodes 104, the local model vₖ is given higher priority.

With the decision function and variables given above, a formal definition of the primal problem for the employed soft margin multitask SVM can be built as:

$$\{ \begin{matrix}\frac{{‖ w ‖}^{2}}{2} + {C}_{1} {\sum }_{k = 1}^{T} {\sum }_{i = 1}^{{n}_{k}} {ξ}_{ik} + \frac{{C}_{2}}{2} {\sum }_{k = 1}^{T} {‖ {v}_{k} ‖}^{2} \to {min}_{{v}_{k} , w , {ξ}_{k}} \\ {y}_{ik} \cdot ( {w}^{T} {x}_{ik} + {v}_{k}^{T} {x}_{ik} ) \geq 1 - {ξ}_{ik} ; k = 1 , … , T ; i = 1 , … , {n}_{k} , \\ {ξ}_{ik} \geq 0 ; k = 1 , … , T ; i = 1 , … , {n}_{k}\end{matrix} .$$

The equation represents that the sum of factors based on the square of the length of the global vector w, the errors caused by outliers, and the square of the regularized length of the local vectors vₖ should be minimized, subject to the constraints shown. Parameters ξᵢₖ represent the distance of point xᵢₖ from the corresponding class's margin if the point is on the wrong side and is 0 otherwise.

The problem above can be expressed/reformulated through the Lagrangian:

$$L ( w , {v}_{k} , ξ ) = \frac{{‖ w ‖}^{2}}{2} + {C}_{1} {\sum }_{k = 1}^{T} {\sum }_{i = 1}^{{n}_{k}} {ξ}_{ik} + \frac{{C}_{2}}{2} {\sum }_{k = 1}^{T} {‖ {v}_{k} ‖}^{2} - {\sum }_{k = 1}^{T} {\sum }_{i = 1}^{{n}_{k}} {η}_{ik} {ξ}_{ik} - {\sum }_{k = 1}^{T} {\sum }_{i = 1}^{{n}_{k}} {α}_{ik} [ {y}_{ik} ( {w}^{T} {x}_{ik} + {v}_{k}^{T} {x}_{ik} ) - 1 + {ξ}_{ik} ] .$$

The Lagrangian includes the Lagrange multipliers ηᵢₖ and αᵢₖ, which can be used to minimize the initial formula. The above primal problem is transformed into a dual problem by expressing w and v as functions of αᵢₖ, yᵢₖ, and xᵢₖ:

$$w = {\sum }_{k = 1}^{T} {\sum }_{i = 1}^{{n}_{k}} {α}_{ik} {y}_{ik} {x}_{ik} , {v}_{k} = \frac{1}{{C}_{1}} {\sum }_{i = 1}^{{n}_{k}} {α}_{ik} {y}_{ik} {x}_{ik} ,$$

where C₁=ηᵢₖ+αᵢₖ. That transformation follows from calculating the partial derivatives of the Lagrangian.

After substituting those formulae for w and vₖ into the original problem, the following dual problem can be formulated:

$$\{ \begin{matrix}\begin{matrix}\frac{1}{2} {\sum }_{k = 1}^{T} {\sum }_{i = 1}^{{n}_{k}} {\sum }_{l = 1}^{T} {\sum }_{j = 1}^{{n}_{l}} {y}_{ik} {y}_{jl} {x}_{ik}^{T} {x}_{jl} {α}_{ik} {α}_{jl} + \frac{1}{2 {C}_{2}} {\sum }_{k = 1}^{T} {\sum }_{i = 1}^{{n}_{k}} {\sum }_{j = 1}^{{n}_{k}} {y}_{ik} {y}_{jk} {x}_{ik}^{T} {x}_{jk} {α}_{ik} {α}_{jk} - \\ {\sum }_{k = 1}^{T} {\sum }_{i = 1}^{{n}_{k}} {α}_{ik} \to {min}_{{α}_{ik}}\end{matrix} \\ 0 \leq {α}_{ik} \leq {C}_{1} ; k = 1 , … , T ; i = 1 , … , {n}_{k}\end{matrix} .$$

The global minimization problem above is solved by sequentially finding minima with respect to αᵢ, k=1, . . . , T, i=1, . . . , nₖ. To do so, the following function of one Lagrange multiplier is minimized:

$${z}_{ik} ( {α}_{ik} ) = {α}_{ik} {y}_{ik} {x}_{ik} ( {\sum }_{l = 1}^{T} {\sum }_{j = 1}^{{n}_{l}} {α}_{jl} {y}_{jl} {x}_{jl} - {α}_{ik} {y}_{ik} {x}_{ik} ) + \frac{1}{2} {α}_{ik}^{2} {y}_{ik}^{2} {‖ {x}_{ik} ‖}^{2} + \frac{1}{{C}_{2}} {α}_{ik} {y}_{ik} {x}_{ik}^{T} {\sum }_{j = 1 , j \neq i}^{{n}_{k}} {α}_{jk} {y}_{jk} {x}_{jk} + \frac{1}{2 {C}_{2}} {α}_{ik}^{2} {y}_{ik}^{2} {‖ {x}_{ik} ‖}^{2} - {α}_{ik} .$$

The above function is convex; hence, an optimal αᵢₖ for a fixed set of other Lagrange multipliers can be found. The resulting set {aᵢₖ}ᵢ₌₁ⁿ^{ₖ} is then substituted into the (j+1)-th global model update, wₖ^{(j+1)}=Σᵢ₌₁ⁿ^{ₖ}aᵢₖxᵢₖ and the corresponding local update:

$$Δ {w}_{k}^{( j + 1 )} = {\sum }_{i = 1}^{{n}_{k}} {x}_{ik} \frac{1 - {y}_{ik} ( {w}^{( j )} + {v}_{k}^{( j )} ) {x}_{ik}}{{‖ {x}_{ik} ‖}^{2} ( 1 - \frac{1}{{C}_{2}} )} , Δ {v}_{k}^{( j )} = \frac{1}{{C}_{2}} {w}_{k}^{( j )} .$$

We have now determined the updated value for the global model parameter w as well as the local model parameter vₖ. It should be appreciated that the update Δwₖ^{(j+1)} can be calculated by the kth participant node 104 using only the global parameters, local model parameter vₖ, and local training data, allowing the participant nodes 104 to update wₖ in a distributed manner without sharing training data or local model parameters. The model trainer 404 may determine the updated values Δwₖ and Δvₖ for each set of regularization parameters.

In the case of multitask regression, the loss function can be changed to a piece-wise function (x)=Σₖ₌₁^{T}Σᵢ₌₁ⁿ^{ₖ}|(w+vₖ)^{T}xᵢₖ−yᵢₖ|_{ε}, where |z|_{ε}=max(0, |z|−ε) to keep the problem tractable. Therefore, the primal problem can be defined as:

$$\{ \begin{matrix}\frac{{‖ w ‖}^{2}}{2} + {C}_{1} {\sum }_{k = 1}^{T} {\sum }_{i = 1}^{{n}_{k}} ( {ξ}_{ik}^{+} + {ξ}_{ik}^{-} ) + \frac{{C}_{2}}{2} {\sum }_{k = 1}^{T} {‖ {v}_{k} ‖}^{2} \to {min}_{{v}_{k} , w , {ξ}_{k}} \\ {y}_{ik} \cdot ( {w}^{T} {x}_{ik} + {v}_{k}^{T} {x}_{ik} ) \geq 1 - ε - {ξ}_{ik}^{-} ; k = 1 , … , T ; i = 1 , … , {n}_{k} , \\ {y}_{ik} \cdot ( {w}^{T} {x}_{ik} + {v}_{k}^{T} {x}_{ik} ) \leq 1 + ε + {ξ}_{ik}^{+} ; k = 1 , … , T ; i = 1 , … , {n}_{k} , \\ {ξ}_{ik}^{-} \geq 0 ; {ξ}_{ik}^{+} \geq 0 ; k = 1 , … , T ; i = 1 , … , {n}_{k}\end{matrix} .$$

The following dual problem for T participants can be defined as

$$\{ \begin{matrix}\begin{matrix}\frac{1}{2} {\sum }_{k = 1}^{T} {\sum }_{i = 1}^{{n}_{k}} {\sum }_{l = 1}^{T} {\sum }_{j = 1}^{{n}_{l}} ( {α}_{ik}^{-} - {α}_{ik}^{+} ) ( {α}_{jl}^{-} - {α}_{jl}^{+} ) {x}_{ik}^{T} {x}_{jl} + \\ \frac{1}{2 {C}_{2}} {\sum }_{k = 1}^{T} {\sum }_{i = 1}^{{n}_{k}} {\sum }_{j = 1}^{{n}_{k}} ( {α}_{ik}^{-} - {α}_{ik}^{+} ) ( {α}_{jk}^{-} - {α}_{jk}^{+} ) {x}_{ik}^{T} {x}_{jk} - \\ {\sum }_{k = 1}^{T} {\sum }_{i = 1}^{{n}_{k}} ( {α}_{ik}^{-} - {α}_{ik}^{+} ) {y}_{ik} + ε {\sum }_{k = 1}^{T} {\sum }_{i = 1}^{{n}_{k}} ( {α}_{ik}^{-} - {α}_{ik}^{+} ) \to {min}_{{α}_{ik}^{-} , {α}_{ik}^{+}}\end{matrix} \\ 0 \leq {α}_{ik}^{+} \leq {C}_{1} ; k = 1 , … , T ; i = 1 , … , {n}_{k} , \\ 0 \leq {α}_{ik}^{-} \leq {C}_{1} ; k = 1 , … , T ; i = 1 , … , {n}_{k}\end{matrix} .$$

After solving the above problem similarly, the following expressions of the global and local model updates are arrived at:

$$Δ {w}_{k}^{( j + 1 )} = {\sum }_{i = 1}^{{n}_{k}} {x}_{ik} \frac{( {w}^{( j )} + {v}_{k}^{( j )} ) {x}_{ik} - {y}_{ik} + ε}{{‖ {x}_{ik} ‖}^{2} ( \frac{1}{{C}_{2}} - 1 )} , Δ {v}_{k}^{( j )} = \frac{1}{{C}_{2}} {w}_{k}^{( j )} .$$

As well as in classification and regression, in the case of anomaly detection, participants do not expose their data directly while training global components w collaboratively. Local model component vₖ is also not transmitted. The primal problem for the multitask one-class SVM is formulated as follows:

$$\{ \begin{matrix}\frac{{‖ w ‖}^{2}}{2} + {C}_{1} {\sum }_{k = 1}^{T} \frac{1}{{n}_{k}} {\sum }_{i = 1}^{{n}_{k}} {ε}_{ik} - {\sum }_{k = 1}^{T} {ϱ}_{k} + \frac{{C}_{2}}{2} {\sum }_{k = 1}^{T} {‖ {v}_{k} ‖}^{2} \to {min}_{{v}_{k} , w , {ε}_{k} , {ϱ}_{k}} \\ {w}^{T} {x}_{ik} + {v}_{k}^{T} {x}_{ik} \geq {ϱ}_{k} - {ε}_{ik} ; k = 1 , … , T ; i = 1 , … , {n}_{k} , \\ {ε}_{ik} \geq 0 ; k = 1 , … , T ; i = 1 , … , {n}_{k}\end{matrix} . \}$$

Furthermore, the dual problem, based on Lagrange multipliers αᵢₖ, which correspond to the weight of the sample xᵢₖ, can be formulated as:

$$\{ \begin{matrix}\frac{1}{2} {\sum }_{k = 1}^{T} {\sum }_{i = 1}^{{n}_{k}} {\sum }_{l = 1}^{T} {\sum }_{j = 1}^{{n}_{l}} {x}_{ik}^{T} {x}_{jl} {α}_{ik} {α}_{jl} + \frac{1}{2 {C}_{2}} {\sum }_{k = 1}^{T} {\sum }_{i = 1}^{{n}_{k}} {\sum }_{j = 1}^{{n}_{k}} {x}_{ik}^{T} {x}_{jk} {α}_{ik} {α}_{jk} \to {min}_{α} \\ 0 \leq {α}_{ik} \leq \frac{{C}_{1}}{{n}_{k}} ; k = 1 , … , T ; i = 1 , … , {n}_{k} , \\ {\sum }_{i = 1}^{{n}_{k}} {α}_{ik} = 1 ; k = 1 , … , T\end{matrix} .$$

Following the same approach as for classification and regression, the updates for the global and local components of the model can be calculated for a specific participant k at an iteration j as:

$$Δ {w}_{k}^{( j + 1 )} = {\sum }_{i = 1}^{{n}_{k} - 1} ( {x}_{ik} - {x}_{{in}_{k}} ) ( {x}_{ik} - {x}_{{in}_{k}} ) \frac{( {w}^{( j )} + {v}_{k}^{( j )} ) ( {x}_{ik} - {x}_{{in}_{k}} )}{{‖ {x}_{ik} - {x}_{{in}_{k}} ‖}^{2} ( 1 - \frac{1}{{C}_{2}} )} , \\ Δ {v}_{k}^{( j )} = \frac{1}{{C}_{2}} {w}_{k}^{( j )} .$$

The subsampler 406, which may be embodied as hardware, firmware, software, virtualized hardware, emulated architecture, and/or a combination thereof as discussed above, is configured to modify the training of the model by the model trainer 404 to subsample the training data. If a potential eavesdropper knows the number of training samples at the participant node 104, it can recover the data after a certain number of iterations. To do this, the eavesdropper has to capture nₖ·d updates, which allows recovering the full set of data points of device k by solving a set of non-linear equations. To avoid this, a vector of random variables pₖ=[p₁, p₂, . . . , pₙₖ], k=1, . . . , T is introduced, and the update calculation for the global model is reformulated as:

$$Δ {\hat{w}}_{k}^{( j + 1 )} = {\sum }_{i = 1}^{{n}_{k}} {p}_{ik} {x}_{ik} \frac{1 - {y}_{ik} ( {w}^{( j )} + {v}_{k}^{( j )} ) {x}_{ik}}{{‖ {x}_{ik} ‖}^{2} ( 1 - \frac{1}{{C}_{2}} )} .$$

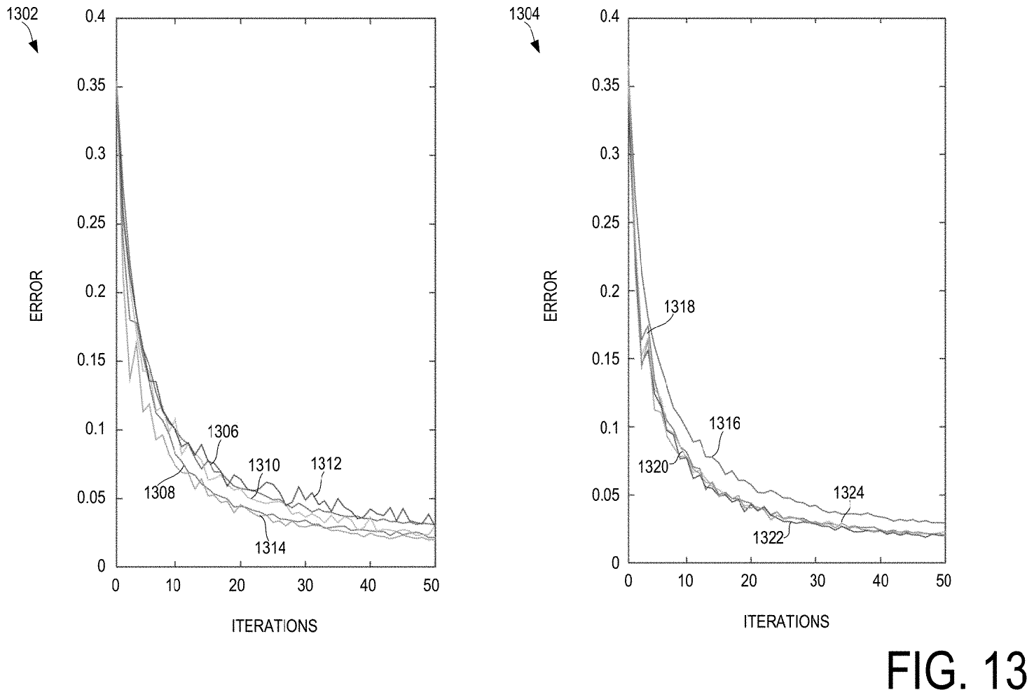

The subsampling may be discrete to discard random points from training or continuous to offset the weights of the points in a certain way. Any suitable distribution for the vector of random variables p may be used, such as a Bernoulli distribution or a Beta distribution, such as β(0.5, 0.5). Some examples of subsampling are described below in regard to FIG. 13.

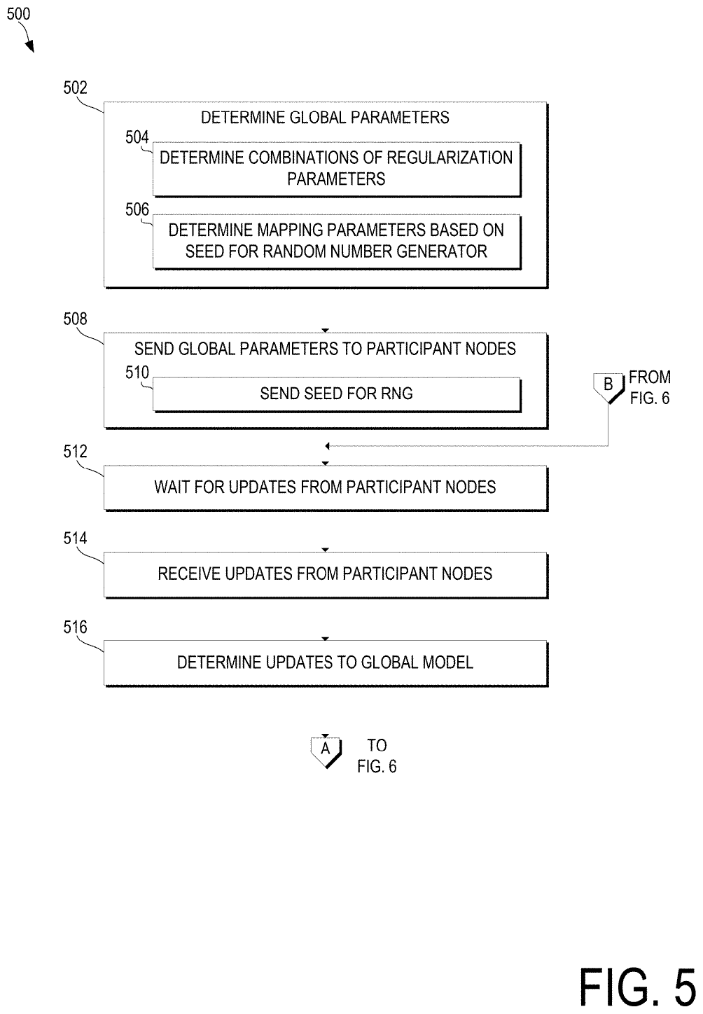

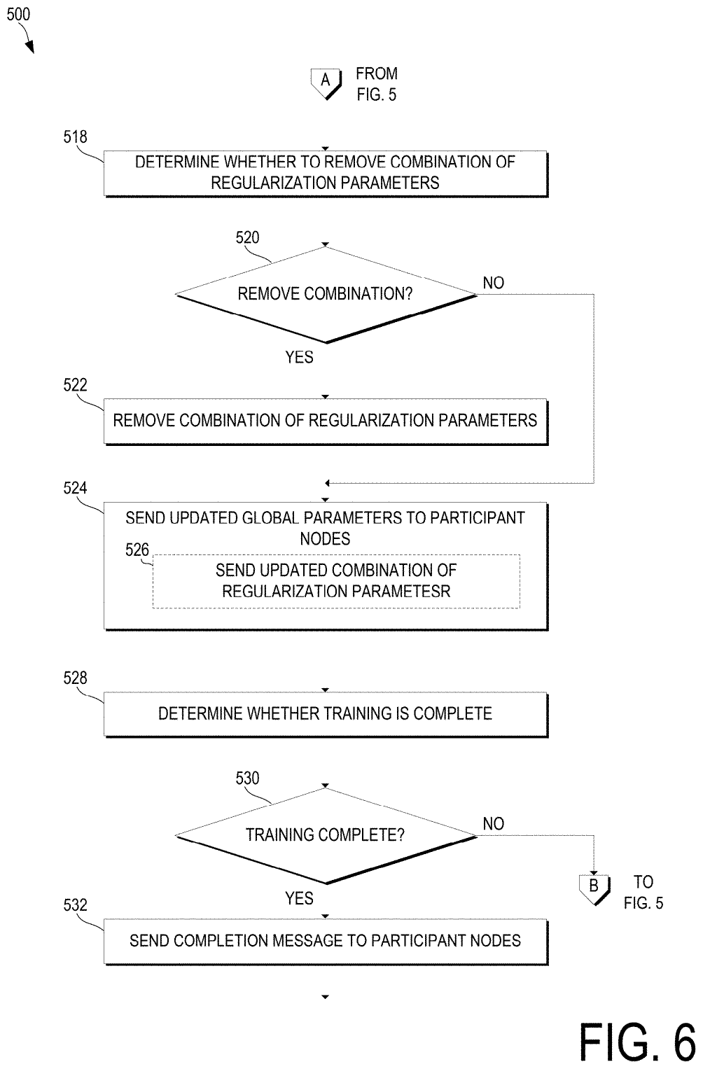

Referring now to FIG. 5, in use, the coordinator node 102 may execute a method 500 for training a non-linear multitask SVM. The method 500 begins in block 502, in which the coordinator node 102 determines global parameters for a global SVM model. The global parameters for the global SVM include a feature mapping such as a random Fourier feature mapping (RFFM), a vector normal to a hyperplane, and one or more sets of regularization parameters. The vector normal to a hyperplane may be initialized to any suitable value, such as all zeros or all ones.

Each set of regularization parameters includes a parameter C₁, which defines the sensitivity to errors caused by outliers, and a parameter C₂, which defines the relative weighting between the global model and the local model. In block 504, the coordinator node 102 determines different combinations of regularization parameters. The coordinator node 102 initially generates a relatively large number of sets of regularization parameters, and the sets of regularization parameters that result in poorer models will be discarded below in block 522. The coordinator node 102 may initially generate any suitable number of sets of regularization parameters, such as 1-1,000.

In some embodiments, in block 506, the coordinator node 102 may determine mapping parameters based on a seed for a random number generator (RNG). In such an embodiment, the coordinator node 102 needs only to send the seed for the RNG to the participant nodes 104 in order for the participant nodes 104 and coordinator node 102 to share mapping parameters.

In block 508, the coordinator node 102 sends the global parameters to each of the participant nodes 104. The coordinator node 102 may include a unique identifier (UID) generated to identify the model being trained in the system 100. In some embodiments, the values of the vector normal to a hyperplane may not be sent as part of the initial message to the participant nodes 104 with the rest of the parameters as its initial value may already be known by the participant nodes 104. In some embodiments, in block 510, the seed for a RNG may be sent in addition to or instead of other mapping parameters.

In block 512, the coordinator node 102 waits for updates from the participant nodes 104. In some embodiments, the coordinator node 102 may wait a pre-defined amount of time. Additionally or alternatively, the coordinator node 102 may wait until a certain fraction of participant nodes 104 have sent back data, such as 10-100% of participant nodes 104.

In block 514, the coordinator node 102 receives updates from the participant nodes 104. Each update includes parameters indicating a new vector normal to a hyperplane for the global model for each set of regularization parameters the coordinator node 102 sent the participant node 104. The update may also include a parameter indicating how well the model for each set of regularization parameters fit the local data. The parameters indicating a new vector normal to a hyperplane may be, e.g., the values of the vector normal to a hyperplane or the difference between the updated values of the vector normal to a hyperplane and the previous values of the vector normal to a hyperplane. In some embodiments, the update may include the task UID and a timestamp. The timestamp may be used to indicate whether the update corresponds to the current training round. It should be appreciated that, in the illustrative embodiment, each participant node 104 calculates updates to a local model that is not shared with the coordinator node 102.

In block 516, the coordinator node 102 determines updates to the global model. For example, the coordinator node 102 may determine an average of the vector normal to a hyperplane determined by each coordinator node 102. The average may be weighted by, e.g., the amount of data each coordinator node 102 has.

Referring now to FIG. 6, in block 518, the coordinator node 102 determines whether a combination of regularization parameters should be removed. In the illustrative embodiment, the coordinator node 102 may remove the lowest-performing set of regularization parameters until a minimum viable number of combinations of parameters are left, such as 1-10. In other embodiments, the coordinator node 102 may decide to remove one or more sets of regularization parameters based on any suitable metric, such as removing all sets of regularization parameters below a certain performance level, which may change depending on what round of training the system 100 is on.

In block 520, if a combination of regularization parameters is to be removed, the method 500 proceeds to block 522, in which the coordinator node 102 removes a combination of regularization parameters. Otherwise, the method 500 jumps to block 524.

In block 524, the coordinator node 102 sends updated global parameters to the participant nodes 104. The coordinator node 102 sends parameters indicating the updates to the global vector normal to a hyperplane. The parameters indicating a new vector normal to a hyperplane may be, e.g., the values of the vector normal to a hyperplane or the difference between the updated values of the vector normal to a hyperplane and the previous values of the vector normal to a hyperplane. In block 526, the coordinator node 102 sends the updated combination of regularization parameters. In some embodiments, the coordinator node 102 may do so by sending an indication of which regularization parameters should no longer be used.

In block 528, the coordinator node 102 determines whether training is complete. The coordinator node 102 may determine that training is complete based on, e.g., a certain number of iterations having elapsed, an error level below a threshold, a change in error level below a threshold, or any suitable combination of the above.

In block 530, if training is not complete, the method 500 loops back to block 512 to wait for additional updates from participant nodes 104. If training is complete, the method 500 proceeds to block 532, in which the coordinator node 102 sends a completion message to the participant nodes 104 indicating that training is complete.

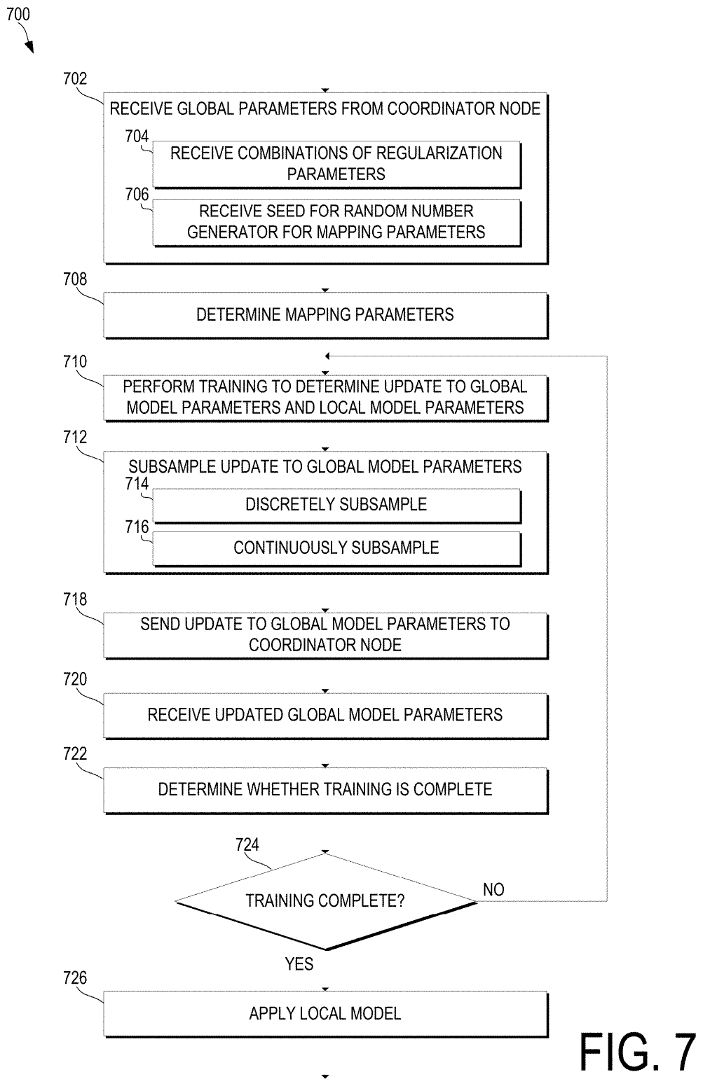

Referring now to FIG. 7, in use, a participant node 104 may execute a method 700 for training a non-linear multitask SVM. The method 700 begins in block 702, in which the participant node 104 receives global parameters for a global SVM model. The global parameters for the global SVM include a feature mapping such as a random Fourier feature mapping (RFFM), a vector normal to a hyperplane, and one or more sets of regularization parameters. In some embodiments, the value of the initial vector normal to a hyperplane may already be known (e.g., may all be zeros or all ones), and the initial vector normal to a hyperplane may be omitted. In block 704, the participant node 104 may receive several combinations of regularization parameters. In block 706, in some embodiments, the participant node 104 may receive a seed for a RNG that can be used to generate mapping parameters.

In block 708, the participant node 104 generates mapping parameters. For example, the participant node 104 may use the seed for the RNG to generate random Fourier feature mapping parameters.

In block 710, the participant node 104 performs training to determine updates to global model parameters and local model parameters. The training may be performed as described above in regard to FIG. 4, a description of which will not be repeated in the interest of clarity. In the illustrative embodiment, the participant node 104 performs training for each combination of regularization parameters received in block 704. In the illustrative embodiment, the participant node 104 determines an updated global vector normal to a hyperplane and an updated local vector normal to a hyperplane. The participant node 104 may also determine a parameter indicating the quality of the model for each combination of regularization parameters.

In block 712, in some embodiments, the participant node 104 subsamples the update to the global model parameters. In block 714, the participant node 104 discretely subsamples by discarding random points from training. Additionally or alternatively, in block 716, the participant node 104 continuously subsamples by offsetting the weights of the points. For example, the participant node 104 may add random noise to each data point.

In block 718, the participant node 104 sends the update to the global model parameters to the coordinator node 102 for each of the combinations of regularization parameters. It should be appreciated that, in the illustrative embodiment, the participant node 104 keeps the updates to the local model parameters private and does not send them to the coordinator node 102. The participant node 104 may also send a parameter indicating the quality of the model for each combination of regularization parameters.

In block 720, the participant node 104 receives parameters indicating updated global model parameters from the coordinator node 102. The participant node 104 may receive the updated global model parameters themselves or may receive the difference between the updated global model parameters and the previous global model parameters. The participant node 104 may also receive an updated combination of regularization parameters, which may omit one or more of the regularization parameters from the previous round.

In block 722, the participant node 104 determines whether training is complete. The participant node 104 may determine that training is complete based on a message from the coordinator node 102, an amount of error in the model, an amount of change in error in the model, or any suitable combination of those.

In block 724, if the training is not complete, the method 700 loops back to block 710 to perform the next round of training. If training is complete, the method 700 proceeds to block 726, in which the participant node 104 applies the local model. The participant node 104 may apply the local model for, e.g., classifying network packets, classifying images, optical character recognition, detecting anomalies, regression, etc.

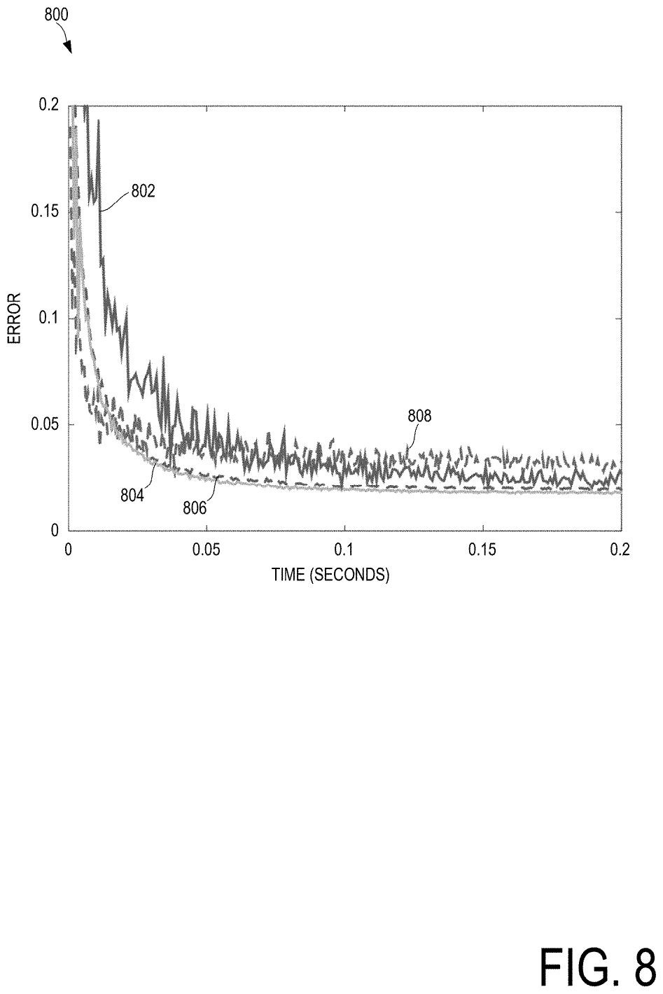

Referring now to FIG. 8, in one embodiment, a plot 800 shows the error as a function of time for various algorithms. Line 802 corresponds to the MOCHA classifier. Line 804 corresponds to one embodiment of a multitask SVM described herein. Line 806 corresponds a SVM trained on local data only. Line 808 corresponds to a global SVM. The multitask SVM described herein represented by line 804 converges about twice as fast as MOCHA and has the lowest error in the final iteration.

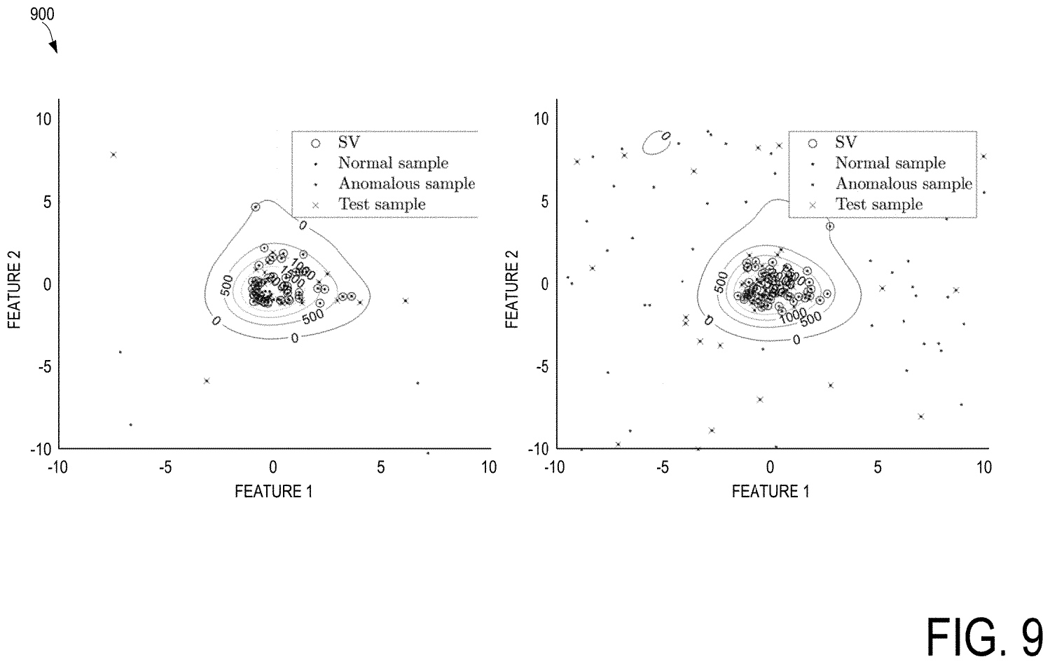

Referring now to FIG. 9, in one embodiment, plots 900 show an example of a multitask anomaly detection model trained for heterogenous data on different participant nodes 104.

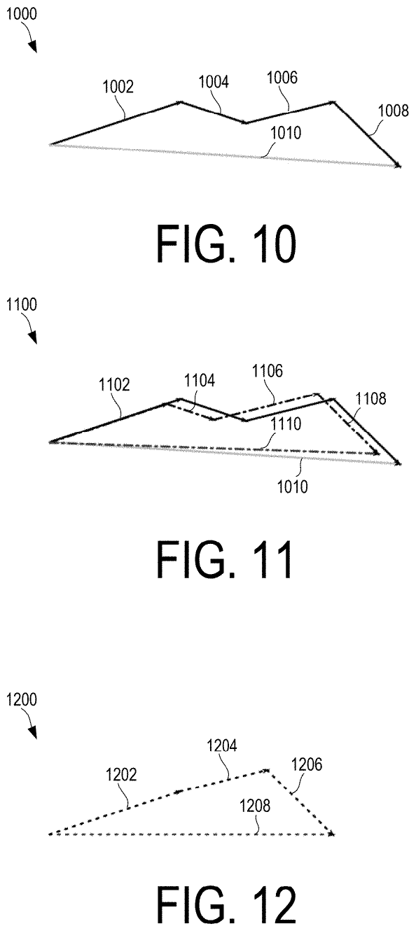

Referring now to FIGS. 10-12, in one embodiment, a diagram 1000 shows how an updated value 1010 for a parameter of the global model is calculated by summing up the contributions from several data points 1002, 1004, 1006, 1008. For continuous subsampling, each data point 1002, 1004, 1006, 1008 is randomly tweaked, resulting in data points 1102, 1104, 1106, 1108 shown in FIG. 11, resulting in subsampled updated value 1110. For discrete subsampling, data point 1004 is dropped, leading to data points 1202, 1204, 1206 adding up to updated value 1208, as shown in FIG. 12.

Referring not to FIG. 13, in one embodiment, various examples of subsampling are shown. In plot 1302, error as a function of a number of iterations is shown for the vector p containing random variables with the Bernoulli distribution. Line 1306 corresponds to using local data only, line 1308 corresponds to applying the error vector to 75% of the data points, line 1310 corresponds to applying the error vector to 50% of the data points, line 1312 corresponds to applying the error vector to 25% of the data points, and line 1314 corresponds to applying the error vector to none of the data points (i.e., without subsampling). In plot 1304, error as a function of a number of iterations is shown for the vector p containing random variables with distribution corresponding to the Beta function β(0.5, 0.5). Line 1316 corresponds to using local data only, line 1318 corresponds to applying the error vector to 75% of the data points, line 1320 corresponds to applying the error vector to 50% of the data points, line 1322 corresponds to applying the error vector to 25% of the data points, and line 1324 corresponds to applying the error vector to none of the data points (i.e., without subsampling). For the Bernoulli sub sampling, the parameter corresponds to the share of points that are left after sub sampling. For the beta distribution, the impact of the share growth is less noticeable, compared to the Bernoulli distribution.

### EXAMPLES

Illustrative examples of the technologies disclosed herein are provided below. An embodiment of the technologies may include any one or more, and any combination of, the examples described below.

Example 1 includes a participant node comprising coordinator node interface circuitry to receive one or more global parameters for a distributed multitask support vector machine from a coordinator node; and model trainer circuitry to perform training for the distributed multitask support vector machine based on the one or more global parameters associated with a global model for the distributed multitask support vector machine, wherein to perform training comprises to determine one or more parameters for the global model and to determine one or more parameters for a local model for the distributed multitask support vector machine, wherein the coordinator node interface circuitry is further to send the one or more parameters for the global model to the coordinator node.

Example 2 includes the subject matter of Example 1, and wherein to receive the one or more global parameters comprises to receive one or more regularization parameters, wherein a first regularization parameter of the one or more regularization parameters indicates a relative weighting between the one or more parameters for the global model and one or more parameters for the local model.

Example 3 includes the subject matter of any of Examples 1 and 2, and wherein to receive the one or more global parameters comprises to receive a plurality of groups of regularization parameters, wherein individual groups of regularization parameters of the plurality of groups of regularization parameters comprise a first regularization parameter that indicates a relative weighting between the one or more parameters for the global model and one or more parameters for the local model and a second regularization parameter that indicates a tolerance to errors caused by outliers and.

Example 4 includes the subject matter of any of Examples 1-3, and wherein to perform training for the distributed multitask support vector machine comprises to perform training for the distributed multitask support vector machine for individual groups of regularization parameters of the plurality of groups of regularization parameters, wherein, after the one or more parameters for the global model are sent to the coordinator node, the coordinator node interface circuitry is further to receive an updated one or more global parameters, wherein to receive the updated one or more global parameters comprises to receive an indication that at least one group of regularization parameters of the plurality of groups of regularization parameters has been removed from the global model.

Example 5 includes the subject matter of any of Examples 1-4, and wherein the participant node does not send the one or more parameters for the local model to the coordinator node.

Example 6 includes the subject matter of any of Examples 1-5, and wherein the distributed multitask support vector machine is an anomaly detection algorithm.

Example 7 includes the subject matter of any of Examples 1-6, and wherein the distributed multitask support vector machine is a classification algorithm.

Example 8 includes the subject matter of any of Examples 1-7, and wherein the distributed multitask support vector machine is a regression algorithm.

Example 9 includes the subject matter of any of Examples 1-8, and wherein to perform training for the distributed multitask support vector machine comprises to perform an alternating direction method of multipliers.

Example 10 includes the subject matter of any of Examples 1-9, and wherein to perform training for the distributed multitask support vector machine comprises to transform local training data using random Fourier feature mapping.

Example 11 includes the subject matter of any of Examples 1-10, and wherein the coordinator node interface circuitry is further to receive a seed for a random number generator from the coordinator node, wherein to transform the local training data comprises to generate the random Fourier feature mapping using the seed and the random number generator.

Example 12 includes the subject matter of any of Examples 1-11, and wherein to perform training for the distributed multitask support vector machine comprises to subsample training data and performing training on the subsampled training data.

Example 13 includes the subject matter of any of Examples 1-12, and wherein to subsample training data comprises to remove a random subset of data points of the training data to generate reduced training data set; and determine one or more parameters for the global model based on the reduced training data set.

Example 14 includes the subject matter of any of Examples 1-13, and wherein to subsample training data comprises to add a random amount of noise to each data points of the training data during training.

Example 15 includes a system comprising the participant node of Example 1, further comprising the coordinator node, the coordinator node comprising parameter initialization circuitry to determine the one or more global parameters for the distributed multitask support vector machine; participant node interface circuitry to send the one or more global parameters to one or more participant nodes, wherein the one or more participant nodes includes the participant node; and receive model updates from the one or more participant nodes, wherein the model updates are based on training data associated with the one or more participant nodes; and model updater circuitry to update one or more of the one or more global parameters based on the model updates from the one or more participant nodes.

Example 16 includes a coordinator node comprising parameter initialization circuitry to determine a one or more global parameters for a distributed multitask support vector machine; participant node interface circuitry to send the one or more global parameters to one or more participant nodes; and receive model updates from the one or more participant nodes, wherein the model updates are based on training data associated with the one or more participant nodes; and model updater circuitry to update one or more of the one or more global parameters based on the model updates from the one or more participant nodes.

Example 17 includes the subject matter of Example 16, and wherein to determine the one or more global parameters comprises to determine one or more regularization parameters, wherein a first regularization parameter of the one or more regularization parameters indicates a relative weighting between one or more parameters for a global model and one or more parameters for a local model.

Example 18 includes the subject matter of any of Examples 16 and 17, and wherein to determine the one or more global parameters comprises to determine a plurality of groups of regularization parameters, wherein individual groups of regularization parameters of the plurality of groups of regularization parameters comprise a first regularization parameter that indicates a relative weighting between the one or more parameters for a global model and one or more parameters for a local model and a second regularization parameter that indicates a tolerance to errors caused by outliers.

Example 19 includes the subject matter of any of Examples 16-18, and wherein the model updater circuitry is further to remove at least one group of regularization parameters from the plurality of groups of regularization parameters to generate a reduced plurality of groups of regularization parameters, wherein the participant node interface circuitry is further to send an indication of the reduced plurality of groups of regularization parameters.

Example 20 includes the subject matter of any of Examples 16-19, and wherein to update the one or more of the one or more global parameters based on the model updates from individual participant nodes of the one or more participant nodes comprises to perform an alternating direction method of multipliers.

Example 21 includes the subject matter of any of Examples 16-20, and wherein the one or more global parameters comprises an indication of a random Fourier feature mapping.

Example 22 includes the subject matter of any of Examples 16-21, and wherein the indication of the random Fourier feature mapping comprises a seed for a random number generator.

Example 23 includes the subject matter of any of Examples 16-22, and wherein individual participant nodes of the one or more participant nodes have training data with different random distributions.

Example 24 includes a method comprising receiving, by a participant node, one or more global parameters for a distributed multitask support vector machine from a coordinator node; performing, by the participant node, training for the distributed multitask support vector machine based on the one or more global parameters associated with a global model for the distributed multitask support vector machine, wherein performing training comprises determining one or more parameters for the global model and determining one or more parameters for a local model for the distributed multitask support vector machine; and sending, by the participant node, the one or more parameters for the global model to the coordinator node.

Example 25 includes the subject matter of Example 24, and wherein receiving the one or more global parameters comprises receiving one or more regularization parameters, wherein a first regularization parameter of the one or more regularization parameters indicates a relative weighting between the one or more parameters for the global model and one or more parameters for the local model.

Example 26 includes the subject matter of any of Examples 24 and 25, and wherein receiving the one or more global parameters comprises receiving a plurality of groups of regularization parameters, wherein individual groups of regularization parameters of the plurality of groups of regularization parameters comprise a first regularization parameter that indicates a relative weighting between the one or more parameters for the global model and one or more parameters for the local model and a second regularization parameter that indicates a tolerance to errors caused by outliers.

Example 27 includes the subject matter of any of Examples 24-26, and wherein performing training for the distributed multitask support vector machine comprises performing training for the distributed multitask support vector machine for individual groups of regularization parameters of the plurality of groups of regularization parameters, further comprising receiving, by the participant node and after the one or more parameters for the global model are sent to the coordinator node, an updated one or more global parameters, wherein receiving the updated one or more global parameters comprises receiving an indication that at least one group of regularization parameters of the plurality of groups of regularization parameters has been removed from the global model.

Example 28 includes the subject matter of any of Examples 24-27, and wherein the participant node does not send the one or more parameters for the local model to the coordinator node.

Example 29 includes the subject matter of any of Examples 24-28, and wherein the distributed multitask support vector machine is an anomaly detection algorithm.

Example 30 includes the subject matter of any of Examples 24-29, and wherein the distributed multitask support vector machine is a classification algorithm.

Example 31 includes the subject matter of any of Examples 24-30, and wherein the distributed multitask support vector machine is a regression algorithm.

Example 32 includes the subject matter of any of Examples 24-31, and wherein performing training for the distributed multitask support vector machine comprises performing an alternating direction method of multipliers.

Example 33 includes the subject matter of any of Examples 24-32, and wherein performing training for the distributed multitask support vector machine comprises transforming local training data using random Fourier feature mapping.

Example 34 includes the subject matter of any of Examples 24-33, and further including receiving, by the participant node, a seed for a random number generator from the coordinator node, wherein transforming the local training data comprises generating the random Fourier feature mapping using the seed and the random number generator.

Example 35 includes the subject matter of any of Examples 24-34, and wherein performing training for the distributed multitask support vector machine comprises subsampling training data and performing training on the subsampled training data.

Example 36 includes the subject matter of any of Examples 24-35, and wherein subsampling training data comprises removing a random subset of data points of the training data to generate reduced training data set; and determining one or more parameters for the global model based on the reduced training data set.

Example 37 includes the subject matter of any of Examples 24-36, and wherein subsampling training data comprises adding a random amount of noise to each data points of the training data during training.

Example 38 includes a method comprising determining, by a coordinator node, one or more global parameters for a distributed multitask support vector machine; sending, by the coordinator node, the one or more global parameters to one or more participant nodes; receiving, by the coordinator node, model updates from the one or more participant nodes, wherein the model updates are based on training data associated with the one or more participant nodes; and updating one or more of the one or more global parameters based on the model updates from the one or more participant nodes.

Example 39 includes the subject matter of Example 38, and wherein determining the one or more global parameters comprises determining one or more regularization parameters, wherein a first regularization parameter of the one or more regularization parameters indicates a relative weighting between one or more parameters for a global model and one or more parameters for a local model.

Example 40 includes the subject matter of any of Examples 38 and 39, and wherein determining the one or more global parameters comprises determining a plurality of groups of regularization parameters, wherein individual groups of regularization parameters of the plurality of groups of regularization parameters comprise a first regularization parameter that indicates a relative weighting between one or more parameters for a global model and one or more parameters for a local model and a second regularization parameter that indicates a tolerance to errors caused by outliers.

Example 41 includes the subject matter of any of Examples 38-40, and further including removing, by the coordinator node, at least one group of regularization parameters from the plurality of groups of regularization parameters to generate a reduced plurality of groups of regularization parameters; and sending, by the coordinator node, an indication of the reduced plurality of groups of regularization parameters.

Example 42 includes the subject matter of any of Examples 38-41, and wherein updating the one or more of the one or more global parameters based on the model updates from the one or more participant nodes comprises performing an alternating direction method of multipliers.

Example 43 includes the subject matter of any of Examples 38-42, and wherein the one or more global parameters comprises an indication of a random Fourier feature mapping.

Example 44 includes the subject matter of any of Examples 38-43, and wherein the indication of the random Fourier feature mapping comprises a seed for a random number generator.

Example 45 includes the subject matter of any of Examples 38-44, and wherein the one or more participant nodes have training data with different random distributions.

Example 46 includes a participant node comprising means for receiving one or more global parameters for a distributed multitask support vector machine from a coordinator node; means for performing training for the distributed multitask support vector machine based on the one or more global parameters associated with a global model for the distributed multitask support vector machine, wherein the means for performing training comprises means for determining one or more parameters for the global model and determining one or more parameters for a local model for the distributed multitask support vector machine; and means for sending the one or more parameters for the global model to the coordinator node.

Example 47 includes the subject matter of Example 46, and wherein the means for receiving the one or more global parameters comprises means for receiving one or more regularization parameters, wherein a first regularization parameter of the one or more regularization parameters indicates a relative weighting between the one or more parameters for the global model and one or more parameters for the local model.

Example 48 includes the subject matter of any of Examples 46 and 47, and wherein the means for receiving the one or more global parameters comprises means for receiving a plurality of groups of regularization parameters, wherein individual groups of regularization parameters of the plurality of groups of regularization parameters comprise a first regularization parameter that indicates a relative weighting between the one or more parameters for the global model and one or more parameters for the local model and a second regularization parameter that indicates a tolerance to errors caused by outliers.

Example 49 includes the subject matter of any of Examples 46-48, and wherein the means for performing training for the distributed multitask support vector machine comprises means for performing training for the distributed multitask support vector machine for individual groups of regularization parameters of the plurality of groups of regularization parameters, further comprising means for receiving, after the one or more parameters for the global model are sent to the coordinator node, an updated one or more global parameters, wherein the means for receiving the updated one or more global parameters comprises means for receiving an indication that at least one group of regularization parameters of the plurality of groups of regularization parameters has been removed from the global model.

Example 50 includes the subject matter of any of Examples 46-49, and wherein the participant node does not send the one or more parameters for the local model to the coordinator node.

Example 51 includes the subject matter of any of Examples 46-50, and wherein the distributed multitask support vector machine is an anomaly detection algorithm.

Example 52 includes the subject matter of any of Examples 46-51, and wherein the distributed multitask support vector machine is a classification algorithm.

Example 53 includes the subject matter of any of Examples 46-52, and wherein the distributed multitask support vector machine is a regression algorithm.

Example 54 includes the subject matter of any of Examples 46-53, and wherein the means for performing training for the distributed multitask support vector machine comprises means for performing an alternating direction method of multipliers.

Example 55 includes the subject matter of any of Examples 46-54, and wherein the means for performing training for the distributed multitask support vector machine comprises means for transforming local training data using random Fourier feature mapping.

Example 56 includes the subject matter of any of Examples 46-55, and further including means for receiving a seed for a random number generator from the coordinator node, wherein the means for transforming the local training data comprises means for generating the random Fourier feature mapping using the seed and the random number generator.

Example 57 includes the subject matter of any of Examples 46-56, and wherein the means for performing training for the distributed multitask support vector machine comprises means for subsampling training data and performing training on the subsampled training data.

Example 58 includes the subject matter of any of Examples 46-57, and wherein the means for subsampling training data comprises means for removing a random subset of data points of the training data to generate reduced training data set; and means for determining one or more parameters for the global model based on the reduced training data set.

Example 59 includes the subject matter of any of Examples 46-58, and wherein the means for subsampling training data comprises means for adding a random amount of noise to each data points of the training data during training.

Example 60 includes a coordinator node comprising means for determining one or more global parameters for a distributed multitask support vector machine; means for sending the one or more global parameters to one or more participant nodes; means for receiving model updates from the one or more participant nodes, wherein the model updates are based on training data associated with the one or more participant nodes; and means for updating one or more of the one or more global parameters based on the model updates from the one or more participant nodes.

Example 61 includes the subject matter of Example 60, and wherein the means for determining the one or more global parameters comprises means for determining one or more regularization parameters, wherein a first regularization parameter of the one or more regularization parameters indicates a relative weighting between one or more parameters for global model and one or more parameters for a local model.

Example 62 includes the subject matter of any of Examples 60 and 61, and wherein the means for determining the one or more global parameters comprises means for determining a plurality of groups of regularization parameters, wherein individual groups of regularization parameters of the plurality of groups of regularization parameters comprise a first regularization parameter that indicates a relative weighting between one or more parameters for a global model and one or more parameters for a local model and a second regularization parameter that indicates a tolerance to errors caused by outliers.

Example 63 includes the subject matter of any of Examples 60-62, and further including means for removing at least one group of regularization parameters from the plurality of groups of regularization parameters to generate a reduced plurality of groups of regularization parameters; and means for sending an indication of the reduced plurality of groups of regularization parameters.

Example 64 includes the subject matter of any of Examples 60-63, and wherein the means for updating the one or more of the one or more global parameters based on the model updates from the one or more participant nodes comprises means for performing an alternating direction method of multipliers.

Example 65 includes the subject matter of any of Examples 60-64, and wherein the one or more global parameters comprises an indication of a random Fourier feature mapping.

Example 66 includes the subject matter of any of Examples 60-65, and wherein the indication of the random Fourier feature mapping comprises a seed for a random number generator.

Example 67 includes the subject matter of any of Examples 60-66, and wherein the one or more participant nodes have training data with different random distributions.

Example 68 includes one or more computer-readable media comprising a plurality of instructions stored thereon that, when executed, causes a participant node to receive a one or more global parameters for a distributed multitask support vector machine from a coordinator node; perform training for the distributed multitask support vector machine based on the one or more global parameters associated with a global model for the distributed multitask support vector machine, wherein to perform training comprises to determine one or more parameters for global model for the distributed multitask support vector machine and to determine one or more parameters for a local model for the distributed multitask support vector machine; and send the one or more parameters for the global model to the coordinator node.

Example 69 includes the subject matter of Example 68, and wherein to receive the one or more global parameters comprises to receive one or more regularization parameters, wherein a first regularization parameter of the one or more regularization parameters indicates a relative weighting between the one or more parameters for the global model and one or more parameters for the local model.

Example 70 includes the subject matter of any of Examples 68 and 69, and wherein to receive the one or more global parameters comprises to receive a plurality of groups of regularization parameters, wherein individual groups of regularization parameters of the plurality of groups of regularization parameters comprise a first regularization parameter that indicates a relative weighting between the one or more parameters for the global model and one or more parameters for the local model and a second regularization parameter that indicates a tolerance to errors caused by outliers.

Example 71 includes the subject matter of any of Examples 68-70, and wherein to perform training for the distributed multitask support vector machine comprises to perform training for the distributed multitask support vector machine for individual groups of regularization parameters of the plurality of groups of regularization parameters, wherein the plurality of instructions further causes the participant node to receive, after the one or more parameters for the global model are sent to the coordinator node, an updated one or more global parameters, wherein to receive the updated one or more global parameters comprises to receive an indication that at least one group of regularization parameters of the plurality of groups of regularization parameters has been removed from the global model.

Example 72 includes the subject matter of any of Examples 68-71, and wherein the participant node does not send the one or more parameters for the local model to the coordinator node.

Example 73 includes the subject matter of any of Examples 68-72, and wherein the distributed multitask support vector machine is an anomaly detection algorithm.

Example 74 includes the subject matter of any of Examples 68-73, and wherein the distributed multitask support vector machine is a classification algorithm.

Example 75 includes the subject matter of any of Examples 68-74, and wherein the distributed multitask support vector machine is a regression algorithm.

Example 76 includes the subject matter of any of Examples 68-75, and wherein to perform training for the distributed multitask support vector machine comprises to perform an alternating direction method of multipliers.

Example 77 includes the subject matter of any of Examples 68-76, and wherein to perform training for the distributed multitask support vector machine comprises to transform local training data using random Fourier feature mapping.

Example 78 includes the subject matter of any of Examples 68-77, and wherein the plurality of instructions further causes the participant node to receive a seed for a random number generator from the coordinator node, wherein to transform the local training data comprises to generate the random Fourier feature mapping using the seed and the random number generator.

Example 79 includes the subject matter of any of Examples 68-78, and wherein to perform training for the distributed multitask support vector machine comprises to subsample training data and performing training on the subsampled training data.

Example 80 includes the subject matter of any of Examples 68-79, and wherein to subsample training data comprises to remove a random subset of data points of the training data to generate reduced training data set; and determine one or more parameters for the global model based on the reduced training data set.

Example 81 includes the subject matter of any of Examples 68-80, and wherein to subsample training data comprises to add a random amount of noise to each data points of the training data during training.

Example 82 includes one or more computer-readable media comprising a plurality of instructions stored thereon that, when executed, causes a coordinator node to determine one or more global parameters for a distributed multitask support vector machine; send the one or more global parameters to one or more participant nodes; receive model updates from the one or more participant nodes, wherein the model updates are based on training data associated with the one or more participant nodes; and update one or more of the one or more global parameters based on the model updates from the one or more participant nodes.

Example 83 includes the subject matter of Example 82, and wherein to determine the one or more global parameters comprises to determine one or more regularization parameters, wherein a first regularization parameter of the one or more regularization parameters indicates a relative weighting between one or more parameters for a global model and one or more parameters for a local model.

Example 84 includes the subject matter of any of Examples 82 and 83, and wherein to determine the one or more global parameters comprises to determine a plurality of groups of regularization parameters, wherein individual groups of regularization parameters of the plurality of groups of regularization parameters comprise a first regularization parameter that indicates a relative weighting between one or more parameters for a global model and one or more parameters for a local model and a second regularization parameter that indicates a tolerance to errors caused by outliers.

Example 85 includes the subject matter of any of Examples 82-84, and wherein the plurality of instructions further causes the coordinator node to remove at least one group of regularization parameters from the plurality of groups of regularization parameters to generate a reduced plurality of groups of regularization parameters; and send an indication of the reduced plurality of groups of regularization parameters.

Example 86 includes the subject matter of any of Examples 82-85, and wherein to update the one or more of the one or more global parameters based on the model updates from the one or more participant nodes comprises to perform an alternating direction method of multipliers.

Example 87 includes the subject matter of any of Examples 82-86, and wherein the one or more global parameters comprises an indication of a random Fourier feature mapping.

Example 88 includes the subject matter of any of Examples 82-87, and wherein the indication of the random Fourier feature mapping comprises a seed for a random number generator.

Example 89 includes the subject matter of any of Examples 82-88, and wherein the one or more participant nodes have training data with different random distributions.

1. A participant node comprising:
coordinator node interface circuitry to receive one or more global parameters for a distributed multitask support vector machine from a coordinator node; and
model trainer circuitry to perform training for the distributed multitask support vector machine based on the one or more global parameters associated with a global model for the distributed multitask support vector machine, wherein to perform training comprises to determine one or more parameters for the global model and to determine one or more parameters for a local model for the distributed multitask support vector machine,
wherein the coordinator node interface circuitry is further to send the one or more parameters for the global model to the coordinator node.

2. The participant node of claim 1, wherein to receive the one or more global parameters comprises to receive one or more regularization parameters, wherein a first regularization parameter of the one or more regularization parameters indicates a relative weighting between the one or more parameters for the global model and one or more parameters for the local model.

3. The participant node of claim 1, wherein to receive the one or more global parameters comprises to receive a plurality of groups of regularization parameters, wherein individual groups of regularization parameters of the plurality of groups of regularization parameters comprise a first regularization parameter that indicates a relative weighting between the one or more parameters for the global model and one or more parameters for the local model and a second regularization parameter that indicates a tolerance to errors caused by outliers and.

4. The participant node of claim 3, wherein to perform training for the distributed multitask support vector machine comprises to perform training for the distributed multitask support vector machine for individual groups of regularization parameters of the plurality of groups of regularization parameters,
wherein, after the one or more parameters for the global model are sent to the coordinator node, the coordinator node interface circuitry is further to receive an updated one or more global parameters,
wherein to receive the updated one or more global parameters comprises to receive an indication that at least one group of regularization parameters of the plurality of groups of regularization parameters has been removed from the global model.

5. The participant node of claim 1, wherein the participant node does not send the one or more parameters for the local model to the coordinator node.

6. The participant node of claim 1, wherein the distributed multitask support vector machine is an anomaly detection algorithm.

7. The participant node of claim 1, wherein the distributed multitask support vector machine is a classification algorithm.

8. The participant node of claim 1, wherein to perform training for the distributed multitask support vector machine comprises to transform local training data using random Fourier feature mapping.

9. The participant node of claim 8, wherein the coordinator node interface circuitry is further to receive a seed for a random number generator from the coordinator node, wherein to transform the local training data comprises to generate the random Fourier feature mapping using the seed and the random number generator.

10. The participant node of claim 1, wherein to perform training for the distributed multitask support vector machine comprises to subsample training data and performing training on the subsampled training data.

11. The participant node of claim 10, wherein to subsample training data comprises to:
remove a random subset of data points of the training data to generate reduced training data set; and
determine one or more parameters for the global model based on the reduced training data set.

12. The participant node of claim 10, wherein to subsample training data comprises to add a random amount of noise to each data points of the training data during training.

13. A system comprising the participant node of claim 1, further comprising the coordinator node, the coordinator node comprising:
parameter initialization circuitry to determine the one or more global parameters for the distributed multitask support vector machine;
participant node interface circuitry to:
send the one or more global parameters to one or more participant nodes, wherein the one or more participant nodes includes the participant node; and
receive model updates from the one or more participant nodes, wherein the model updates are based on training data associated with the one or more participant nodes; and
model updater circuitry to update one or more of the one or more global parameters based on the model updates from the one or more participant nodes.

14. A coordinator node comprising:
parameter initialization circuitry to determine a one or more global parameters for a distributed multitask support vector machine;
participant node interface circuitry to:
send the one or more global parameters to one or more participant nodes; and
receive model updates from the one or more participant nodes, wherein the model updates are based on training data associated with the one or more participant nodes; and
model updater circuitry to update one or more of the one or more global parameters based on the model updates from the one or more participant nodes.

15. The coordinator node of claim 14, wherein to determine the one or more global parameters comprises to determine a plurality of groups of regularization parameters, wherein individual groups of regularization parameters of the plurality of groups of regularization parameters comprise a first regularization parameter that indicates a relative weighting between the one or more parameters for a global model and one or more parameters for a local model and a second regularization parameter that indicates a tolerance to errors caused by outliers,
wherein the model updater circuitry is further to remove at least one group of regularization parameters from the plurality of groups of regularization parameters to generate a reduced plurality of groups of regularization parameters,
wherein the participant node interface circuitry is further to send an indication of the reduced plurality of groups of regularization parameters.

16. The coordinator node of claim 14, wherein to update the one or more of the one or more global parameters based on the model updates from individual participant nodes of the plurality of participant nodes comprises to perform an alternating direction method of multipliers.

17. The coordinator node of claim 14, wherein individual participant nodes of the plurality of participant nodes have training data with different random distributions.

18. One or more computer-readable media comprising a plurality of instructions stored thereon that, when executed, causes a participant node to:
receive a one or more global parameters for a distributed multitask support vector machine from a coordinator node;
perform training for the distributed multitask support vector machine based on the one or more global parameters associated with a global model for the distributed multitask support vector machine, wherein to perform training comprises to determine one or more parameters for the global model for the distributed multitask support vector machine and to determine one or more parameters for a local model for the distributed multitask support vector machine; and
send the one or more parameters for the global model to the coordinator node.

19. The one or more computer-readable media of claim 18, wherein to receive the one or more global parameters comprises to receive a plurality of groups of regularization parameters, wherein individual groups of regularization parameters of the plurality of groups of regularization parameters comprise a first regularization parameter that indicates a tolerance to errors caused by outliers and a second regularization parameter that indicates a relative weighting between the one or more parameters for the global model and one or more parameters for the local model,
wherein to perform training for the distributed multitask support vector machine comprises to perform training for the distributed multitask support vector machine for individual groups of regularization parameters of the plurality of groups of regularization parameters,
wherein, after the one or more parameters for the global model are sent to the coordinator node, the plurality of instructions further causes the participant node to receive an updated one or more global parameters,
wherein to receive the updated one or more global parameters comprises to receive an indication that at least one group of regularization parameters from the plurality of groups of regularization parameters has been removed from the global model.

20. The one or more computer-readable media of claim 18, wherein to perform training for the distributed multitask support vector machine comprises to subsample training data and performing training on the subsampled training data.
